(19) United States
(12) Patent Application Publication
(10) Pub. No.: US 2012/0218308 A1
(43) Pub. Date: Aug. 30, 2012

(54) ELECTRONIC APPARATUS WITH TOUCH SCREEN AND DISPLAY CONTROL METHOD THEREOF

(75) Inventors: Hung-Yi Lin, Taipei City (TW); Wen-Shiu Hsu, Taipei City (TW); Jung-Hsing Wang, Taipei City (TW); Ping-Cheng Hsieh, Taipei City (TW)

(73) Assignee: ASUSTek COMPUTER INC., Taipei (TW)

(21) Appl. No.: 13/404,163

(22) Filed: Feb. 24, 2012

(30) Foreign Application Priority Data
Feb. 25, 2011 (TW) 100106509

(51) Int. Cl. G09G 5/00

(52) U.S. Cl. 345/660

(57) ABSTRACT

A display control method of a touch control screen and an electronic device applying the same are provided. According to the method, small user interfaces are magnified, and the user selects a target user interface according to a magnified zone. The method includes steps of: forming a touch boundary according to a position signal of a touch point; determining whether the touch boundary collides with a user interface; executing an image magnifying action according to the touch boundary and displaying the magnified zone on the touch control screen if the touch boundary collides with the user interface at the touch control screen; vanishing the touch point on the touch control screen after moving the touch point to a target user interface to execute a corresponding function of the target user interface via a control application module.

### CONTROL METHOD THEREOF

This application claims the benefit of Taiwan application Serial No. 100106509, filed Feb. 25, 2011, the subject matter of which is incorporated herein by reference.

### BACKGROUND OF THE INVENTION

1. Field of the Invention

The invention relates to an electronic device and a display control method thereof and, more particularly, to an electronic device with a touch control screen and a display control method thereof.

2. Description of the Related Art

As computer technology develops, the computer system has a big change which is to utilize a touch control screen and brings more convenient. Consequently, users control and input commands to computers simply via touching (or tapping) instead of clicking by a mouse.

In the most popular operation systems, only some specific programs support the scale function for users to re-size the viewing images. However, it encounters the problems that not all the images or command input areas can be scaled on the touch control screen for users to edit or taps in a partial enlarged zone, which is rather inconvenient.

FIG. 1 is a schematic diagram showing a conventional operation system. A toolbar 110 is displayed at the touch control screen 100 when the program is executed, and the toolbar 110 includes multiple user interfaces, such as a start button 112 and a network state icon 114. When a program 120 of the operation system is executed, the program 120 performs corresponding user interfaces, such as a close button 122, a maximize button 124 and a minimize button 126. When the user uses a mouse to control the program 120, a cursor 150 moves corresponding to the moving of the mouse, and buttons on the mouse are used to interact with all of the user interfaces at the screen. The user can tap on the user interface (such as the functional button or the state icon) precisely according to the position of the cursor 150 at the screen 100, which is convenient in operation.

However, since the size of the user interface in the conventional operation system is smaller than the touching area of the finger 160, when the user taps on user interfaces at the touch control screen 100 with a finger 160 instead of the mouse, it is difficult to tap the user interface precisely. For example, some user interfaces are close to each other, the user does not know whether he or she taps on the right user interface (the functional button or the state icon). Consequently, the operation system may execute an unwanted function due to a tap by mistake, and it is rather inconvenient for the user.

For example, when the user wants to maximize the program 120, the user should tap the maximize button 124 with the finger 160. However, the user may tap the minimize button 126 or the close button 122 by mistake, and thus the operation system executes an unwanted function.

### BRIEF SUMMARY OF THE INVENTION

A display control method of a touch control screen is disclosed and the touch control screen is used in an electronic device. The display control method includes following steps: forming a touch boundary according to a position signal of a touch point; determining whether the touch boundary collides with a user interface at the touch control screen; executing an image magnifying action according to the touch boundary and displaying a magnified zone on the touch control screen if the touch boundary collides with the user interface at the touch control screen; moving the touch point away from the touch control screen after moving the touch point to a target user interface to execute a corresponding function of the target user interface via a control application module.

An electronic device with a touch control screen includes a touch unit, a gesture engine, an image magnifying application module, a filter unit and a control application module. The touch unit generates a position signal corresponding to a touch point at the touch control screen. The gesture engine receives the position signal, forms a touch boundary and determines whether the touch boundary collides with a user interface at the touch control screen. The image magnifying application module executes an image magnifying action and displays a magnified zone on the touch control screen when the touch boundary collides with the user interface at the touch control screen. The filter unit gets a final position signal before the position signal disappears and outputs the final position signal after the touch point is moved to the target user interface and the touch point is moved away. The control application module receives the final position signal.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional operation system;

FIG. 2 is a schematic diagram showing architecture of an electronic device with a touch control screen in an embodiment;

FIG. 3a to FIG. 3d are schematic diagrams showing display and control steps on an electronic device in an embodiment;

FIG. 4a to FIG. 4c are schematic diagrams showing display and control steps on an electronic device in another embodiment; and

FIG. 5 is a flow chart showing steps of a display control method applied to an electronic device with a touch control screen.

### DETAILED DESCRIPTION OF THE EMBODIMENTS

An electronic device with a touch control screen and a display control method thereof are disclosed. In an embodiment, the electronic device includes a plurality of application modules and driving modules. When the user selects a user interface in smaller size, the electronic device forms a touch boundary according to a touch point and queries a user interface layout that is built-in in the operation system. When the touch boundary collides with the user interface, the touch boundary is magnified to get the closest user interfaces to the touch point, and then the user can move the touch point to the target user interface accordingly. Consequently, when the touch point is vanished on the touch control screen, the operation system can execute the certain function corresponding to a position signal based on the final touch point.

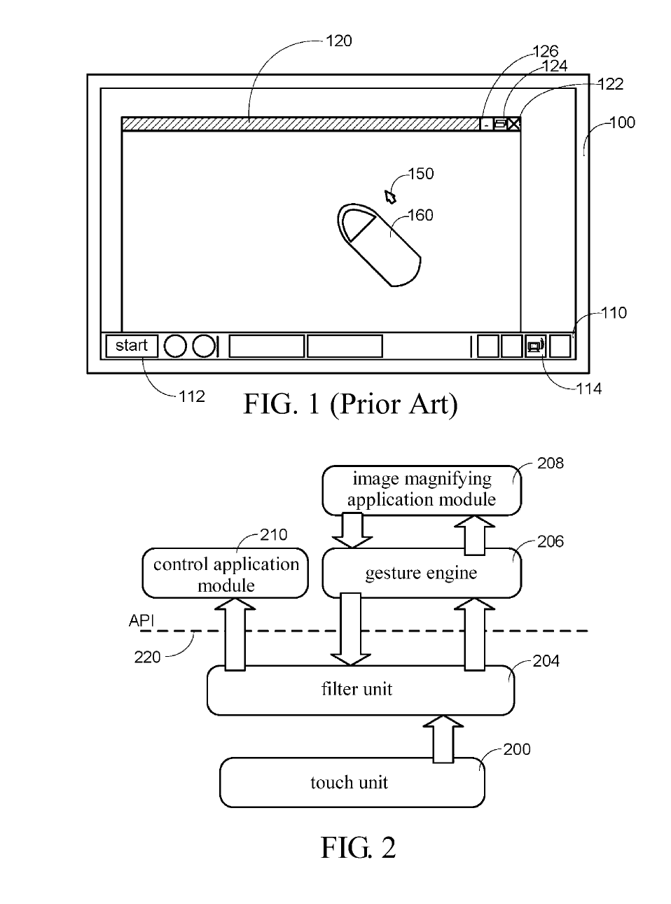

FIG. 2 is a schematic diagram showing architecture of an electronic device with a touch control screen in an embodiment. The electronic device includes a touch unit 200 and a filter unit 204. The touch unit 200 includes a driving module of the touch control screen, the driving module outputs the corresponding position signal according to the touch point at the touch control screen, and the position signal may be a coordinate signal. The filter unit 204 may also include a driving module to receive the position signal outputted by the touch unit 200 and filter the position signal. In an embodiment, the filter unit 204 is firmware.

The electronic device also includes a gesture engine 206, an image magnifying application module 208 and a control application module 210. The filter unit 204 transmits the position signal to the gesture engine 206 and the control application module 210 via an application module interface 220. The gesture engine 206 forms a touch boundary according to the received position signal, and the touch boundary includes the touch point therein. The control application program may be a windows control application program.

After the touch boundary is formed, the gesture engine 206 queries the user interface layout built in the operation system via the relating coordinates of the touch boundary and determines whether the touch boundary collides with the user interface at the touch control screen accordingly. For example, when the touch boundary collides with a first user interface, the image magnifying application module 208 magnifies a zone including the touch point and the first user interface in nearby area, and the magnified zone is displayed at the touch control screen. Then, the user can move the touch point to confirm the touched user interface.

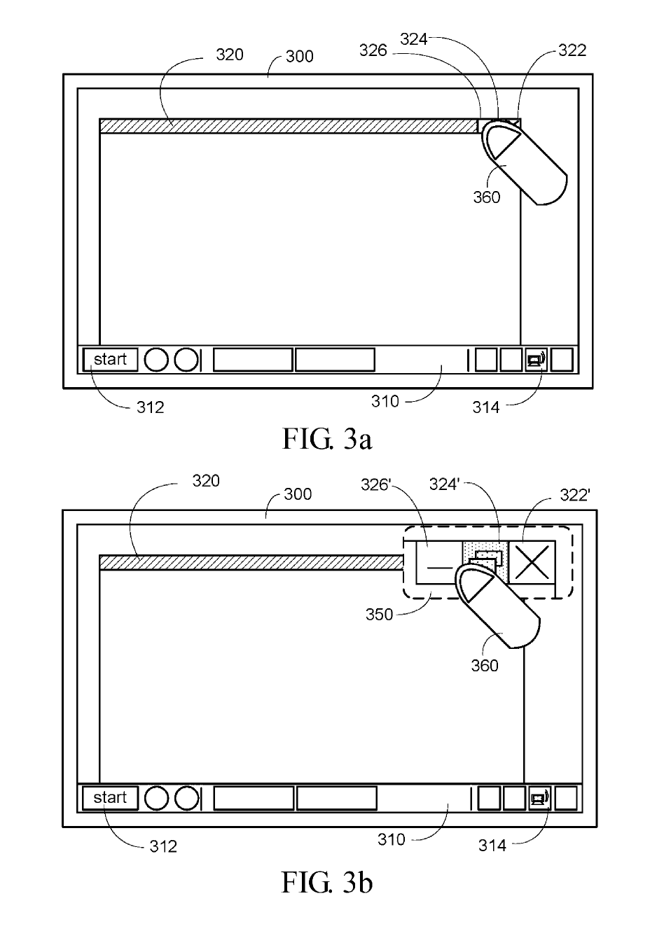

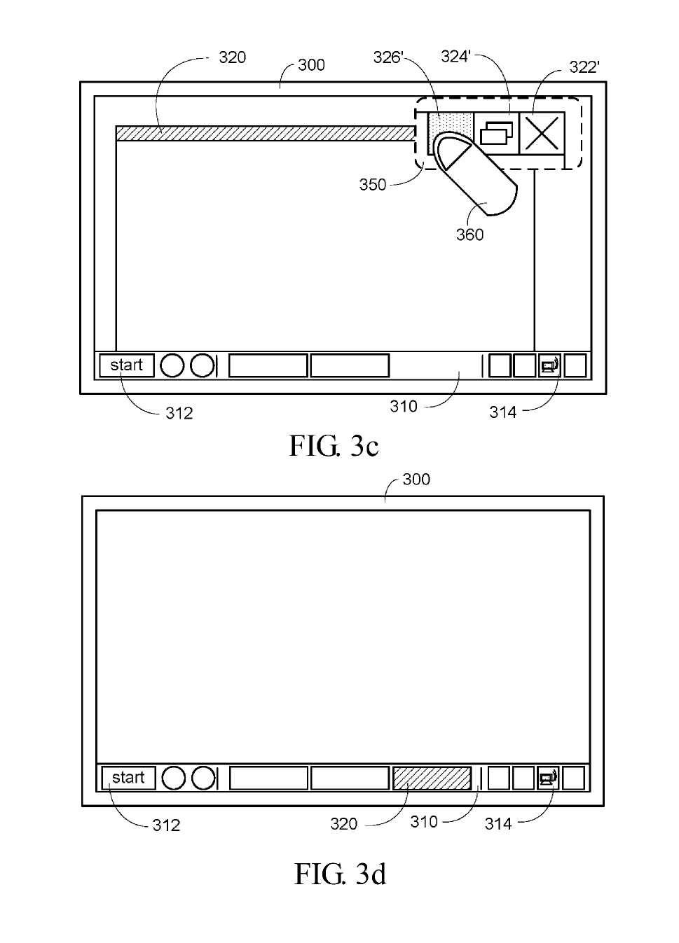

FIG. 3a to FIG. 3d are schematic diagrams showing display and control steps on an electronic device in an embodiment. As shown in FIG. 3a, a toolbar 310 of the operation system is displayed at the touch control screen 300 and the toolbar 310 includes a plurality of user interfaces, such as the start button 312 and the network state icon 314. When a module 320 is executed in the operation system, the module 320 also includes the corresponding user interfaces, such as a close button 322, a maximize button 324 and a minimize button326.

If the user wants to minimize the module 320, the user should touch the minimize button326 with the finger 360. As shown in FIG. 3a, when the user touches the user interface in small size with the finger, the touch unit 200 generates the position signal, such as a coordinate in X-axis and Y-axis, according to the touch point and transmits the position signal to the filter unit 204 and the gesture engine 206.

Then, the gesture engine 206 forms the touch boundary according to the position signal. If the touch boundary is rectangular, the coordinates of the four corners of the touch boundary are (x+Δx, y+Δy), (x+Δx, y−Δy), (x−Δx, y+Δy) and (x−Δx, y−Δy). The touch boundary can be adjusted and its shape may also be a circle or a polygon, which is not limited.

The gesture engine 206 queries the user interface layout built in the operation system via the relating coordinate of the touch boundary and determine whether the touch boundary collides with the user interface at the touch control screen. When the position of the touch boundary and the position of the user interface are overlapped, it is regarded that the touch boundary collides with the user interface.

For example, when the gesture engine 206 confirms that the touch boundary collides with or overlaps a user interface of the close button 322, the maximize button 324 or the minimize button326, the image magnifying application module 208 executes the image magnifying action according to the touch boundary and displays the magnified zone at the touch control screen.

As shown in FIG. 3b, the image magnifying application module 208 generates a magnified zone 350 after the image magnifying action, and the close button 322′, the maximize button 324′ and the minimize button 326′ are displayed in the magnified zone 350. The user can know that the touch point of the finger 360 is at the maximize button 324′ but not the minimize button326′.

Then, the user moves the finger 360 left towards the minimize button326′. As shown in FIG. 3c, the finger 360 of the user contacts with the minimize button326′.

When the user confirms that the finger 360 contacts with the minimize button326′, he or she moves the finger 360 away from the screen. The filter unit 204 transmits the final position signal to the control application module 210 when the finger moves away from the screen, and the operation system confirms that the final position is at the minimize button 326. Consequently, as shown in FIG. 3d, the module 320 minimizes the window, and the minimized window becomes a new user interface at the toolbar 310.

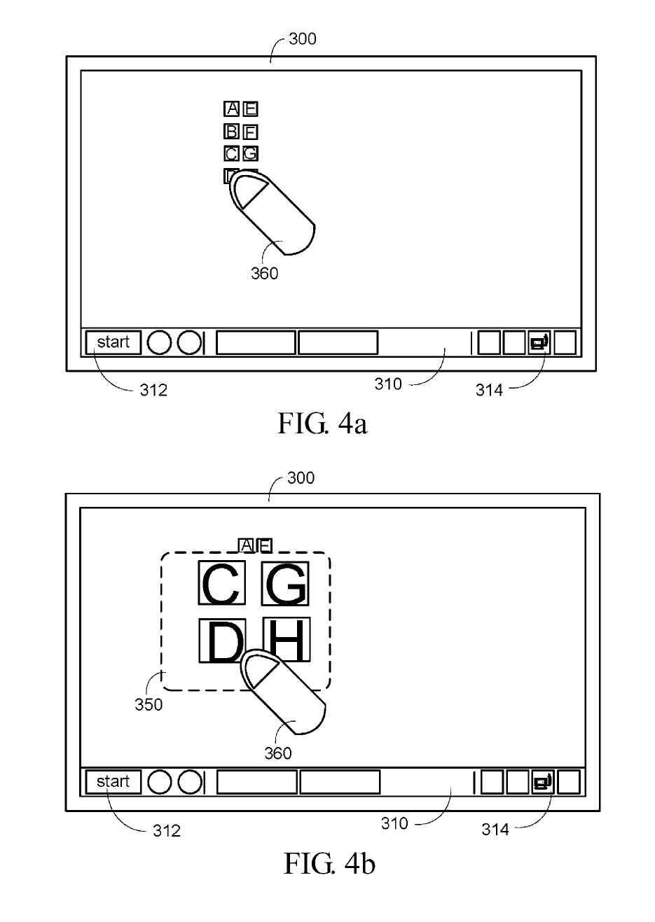

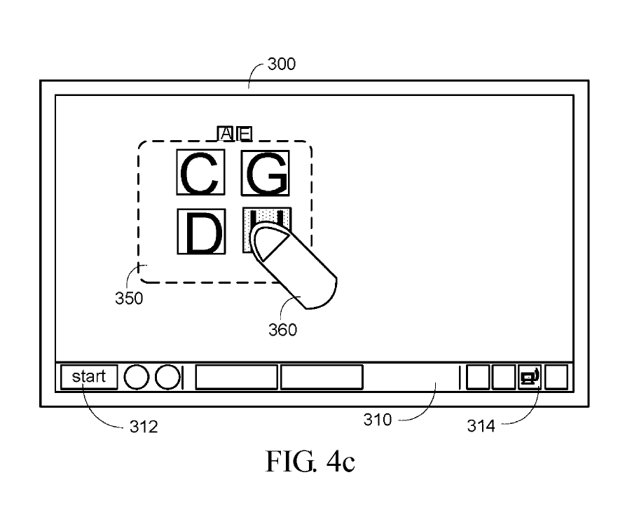

FIG. 4a to FIG. 4c are schematic diagrams showing display and control steps on an electronic device in another embodiment. As shown in FIG. 4a, the touch control screen 300 displays the toolbar 310 of the operation system, and the toolbar 310 includes a plurality of the user interfaces, such as the start button 312 and the network state icon 314. A desktop of the operation system displays eight user interfaces (the user interface A to H) for taping.

If the user wants to tap the user interface “H”, the user can put the finger 360 near or on the user interface “H”. As shown in FIG. 4a, the touch unit 200 generates the position signal, such as (x, y), according to the touch point of the finger and outputs the position signal to the filter unit 204 and the gesture engine 206.

Then, the gesture engine 206 forms the touch boundary according to the position signal. The touch boundary may be in different shapes. The gesture engine 206 queries the user interface layout built in the operation system via the relating coordinates of the touch boundary and determines whether the touch boundary collides with the user interface at the touch control screen.

For example, when the gesture engine 206 confirms that the touch boundary collides with the user interface “D” and the user interface “H”, the image magnifying application module 208 executes the image magnifying action to the touch point and the user interfaces according to the touch boundary and displays the magnified zone at the touch control screen.

As shown in FIG. 4b, after the image magnifying action, the magnified zone 350 displays the user interfaces “D” and “H”. The user gets that the finger 360 does not contact with the user interface “H” via the magnified zone 350.

Then, the user moves the finger 360 right towards the user interface “H”. Thus, as shown in FIG. 4c, the finger 360 contacts with the user interface

When the user confirms the finger 360 contacts with the user interface “H”, he or she only needs to leave the finger 360 away from the screen. The filter unit 204 transmits the final position signal to the control application module 210 when the leave moves away from the screen, and the operation system confirms that the final position is at the user interface “H”. Consequently, the operation system executes the function of taping the user interface “H”.

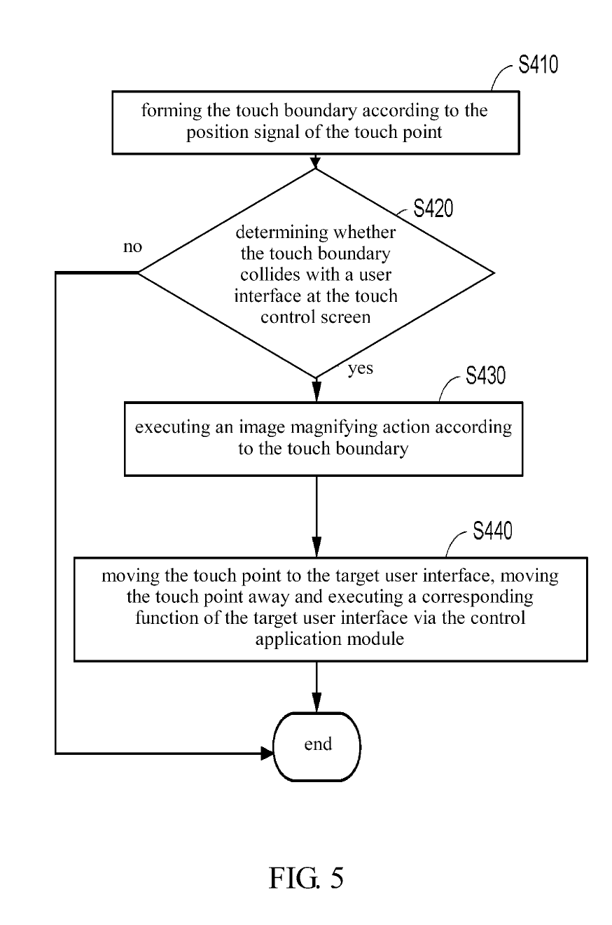

FIG. 5 is a flow chart showing steps of a display control method applied to an electronic device with a touch control screen. The electronic device has an architecture shown in FIG. 2. It includes the touch unit 200, the driving module of the filter unit 204, the driving module of the gesture engine 206, the image magnifying application module 208 and the control application module 210.

First, the touch boundary is formed according to the position signal of the touch point (step S410). It is determined whether the touch boundary collides with a user interface at the touch control screen (step S420). If not, the process goes to the end. If yes, an image magnifying action is executed to all of the collided user interfaces according to the touch boundary and displaying a magnified zone on the touch control screen (step S430). Finally, the user moves the touch point to the target user interface and moves the touch point away, and the control application module executes a corresponding function of the target user interface (step S440).

The electronic device with the touch control screen can load multiple application modules and driving modules. The electronic device may be a desktop computer, a portable computer or a notebook computer. When the user selects a user interface in small size, the image magnifying action is executed near the touch point, and the user selects the target user interface according to the magnified zone. Thus, the mistakes in operating the electronic device due to the large contact area of the finger can be avoided.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A display control method of a touch control screen of an electronic device, comprising:
forming a touch boundary according to a position signal of a touch point;
determining whether the touch boundary collides with a user interface on the touch control screen;
executing an image magnifying action according to the touch boundary and displaying a magnified zone on the touch control screen if the touch boundary collides with the user interface on the touch control screen; and
vanishing the touch point from the touch control screen after moving the touch point to a target user interface to execute a corresponding function of the target user interface via a control application module.

2. The display control method of the touch control screen according to claim 1, wherein the electronic device includes a touch unit and a gesture engine, the touch unit generates the position signal according to the touch point, and the gesture engine forms the touch boundary according to the position signal.

3. The display control method of the touch control screen according to claim 2, wherein in the step of determining whether the touch boundary collides with the user interface at the touch control screen, the gesture engine queries via a user interface layout that built-in in an operation system.

4. The display control method of the touch control screen according to claim 1, wherein the electronic device includes an image magnifying application module to execute the image magnifying action.

5. The display control method of the touch control screen according to claim 1, wherein in the step of vanishing the touch point on the touch control screen after moving the touch point to the target user interface to execute a corresponding function of the target user interface via a control application module, a filter unit of the electronic device gets a final position signal of the touch point after the touch point is vanished and transmits the final position signal to the control application module to execute the corresponding function of the target user interface.

6. An electronic device with a touch control screen, comprising:
a touch unit generating a position signal corresponding to a touch point at the touch control screen;
a gesture engine receiving the position signal and forming a touch boundary, determining whether the touch boundary collides with a user interface at the touch control screen;
an image magnifying application module executing an image magnifying action and displaying a magnified zone on the touch control screen when the touch boundary collides with the user interface at the touch control screen;
a filter unit getting a final position signal before the position signal disappears and outputting the final position signal after the touch point is moved to the target user interface and the touch point is moved away; and
a control application module receiving the final position signal.

7. The electronic device with the touch control screen according to claim 6, wherein the gesture engine queries whether the touch boundary collides with the user interface via a user interface layout built in an operation system.
